(19) United States
(12) Patent Application Publication
(10) Pub. No.: US 2005/0216603 A1
(43) Pub. Date: Sep. 29, 2005

(54) Method and apparatus for providing USB device support to an interactive system

(76) Inventor: Ted R. Michaud, Medford, NJ (US)

Correspondence Address: GENERAL INSTRUMENT CORPORATION, 101 Tournament Drive, Horsham, PA, 19044, US

(21) Appl. No.: 10/810,149

(22) Filed: Mar. 26, 2004

(51) Int. Cl. G06F 15/16

(52) U.S. Cl. 709/250; 709/249

(57) ABSTRACT

The present invention is a method and apparatus for providing USB device support for an interactive system. USB devices 122-128 are communicatively coupled to a home gateway device 110 in an interactive system 100 at a subscriber location 104. Upon connection, the home gateway device 110 determines USB device information about the USB device, and communicates this USB device information to a USB server 108. The USB server 108 then locates an appropriate USB driver for the USB device, and then communicates one or more messages comprising USB driver functionality to the home gateway device 110.

### FIELD OF THE INVENTION

The present invention relates to the field of interactive systems, and more particularly, to a method and apparatus for providing universal serial bus device support in an interactive system.

### BACKGROUND OF THE INVENTION

As personal computers (PCs) became an integral part of the household entertainment regime, PC users soon found exciting peripheral devices in the marketplace that could be connected to their PC. However, before the introduction of USB (Universal Serial Bus) technology, connecting peripheral devices to a personal computer was an undertaking best left to the highly competent and computer savvy portion of the population. This arduous task first involved determining which port to use, which to an average layman user, could be a completely bewildering process in itself. Then, a special add-in card would usually have to be installed and various internal switches would have to be set, which would involve the careful task of opening the personal computer. Additionally, more settings on the PC would have to be configured properly, or else the peripheral device would not operate.

With all of these tasks required for adding a peripheral device, it is not surprising that the “plug and play” concept introduced by USB technology exploded once introduced in the market. With USB technology, PC users could now easily and successfully plug peripheral devices into their computer without the painstaking process formerly required to enable such functionality. After plugging in the USB device, the user could simply download or locate an appropriate USB driver on the PC, and the USB device would operate.

Now, another device is gaining popularity and functionality: the home gateway device. While current set-top devices mainly provide a television signal to a television device, set-top devices are being introduced with a massive amount of additional functionality, managing communications between devices in the home as well as managing communications between the subscriber location and the outside world. These massively functional set-top devices are known in the marketplace as “home gateway devices,” and the system of devices and resources managed by the home gateway device is known as an “interactive system.”

As the home gateway device becomes an integral part of the average household, subscribers will again discovery a world of exciting connectible peripheral devices. These peripheral devices may be connected to the home gateway device, or connected to a device that is coupled to the home gateway device. These peripheral devices to add to the interactive system include, but are not limited to, scanners, digital cameras, joysticks, and printers.

While many of these peripheral devices comprise USB functionality (hereinafter referred to as “USB devices”), the set-top device is not equipped to offer seamless “plug and play” functionality for these devices. In fact, only a limited range of these USB devices can be supported by the home gateway device. Furthermore, of this limited range of USB devices, functionality usually requires a software download or installation of a plug-in applet, both of which are difficult tasks given that the interface of the home gateway device is not configured to allow for such tasks.

Therefore, there is a need in the art for a more effective method and apparatus for providing functionality to USB devices in a home gateway device. There is also a need in the art for a method and apparatus for providing “plug and play” functionality for these USB devices, without requiring any additional steps on the part of the user.

### SUMMARY OF THE INVENTION

The present invention overcomes the aforementioned deficiencies in the prior art by providing a method and apparatus for providing USB device support in an interactive system. After a USB device is connected to a home gateway device, the home gateway device determines the USB device information about the USB device. This USB device information is communicated to the USB server.

Upon receiving the USB device information, the USB server determines the appropriate USB driver for the USB device. The USB server then communicates a message comprising USB driver functionality to support the USB device to the home gateway device. Thus, the present invention allows the home gateway device to support the USB device without actually comprising the appropriate USB driver.

### BRIEF DESCRIPTION OF THE DRAWINGS

For a fuller understanding of the present invention, reference is made to the following description taken in connection with the accompanying drawings, in which:

FIG. 1 is a block diagram of an exemplary interactive system in accordance with an embodiment of the present invention.

FIG. 2 is a flow diagram illustrating the method of the present invention from the perspective of the home gateway device 110.

FIG. 3 is a flow diagram illustrating the method of the present invention, from the perspective of the USB server, when the USB memory device does not include the USB driver for the USB device.

### DETAILED DESCRIPTION

Generally, the present invention provides a method and apparatus for supporting USB devices in an interactive system. More particularly, the present invention is a method and apparatus for supporting a broader range of USB devices by purporting USB driver functionality to the home gateway device if the home gateway device does not comprise the necessary USB driver.

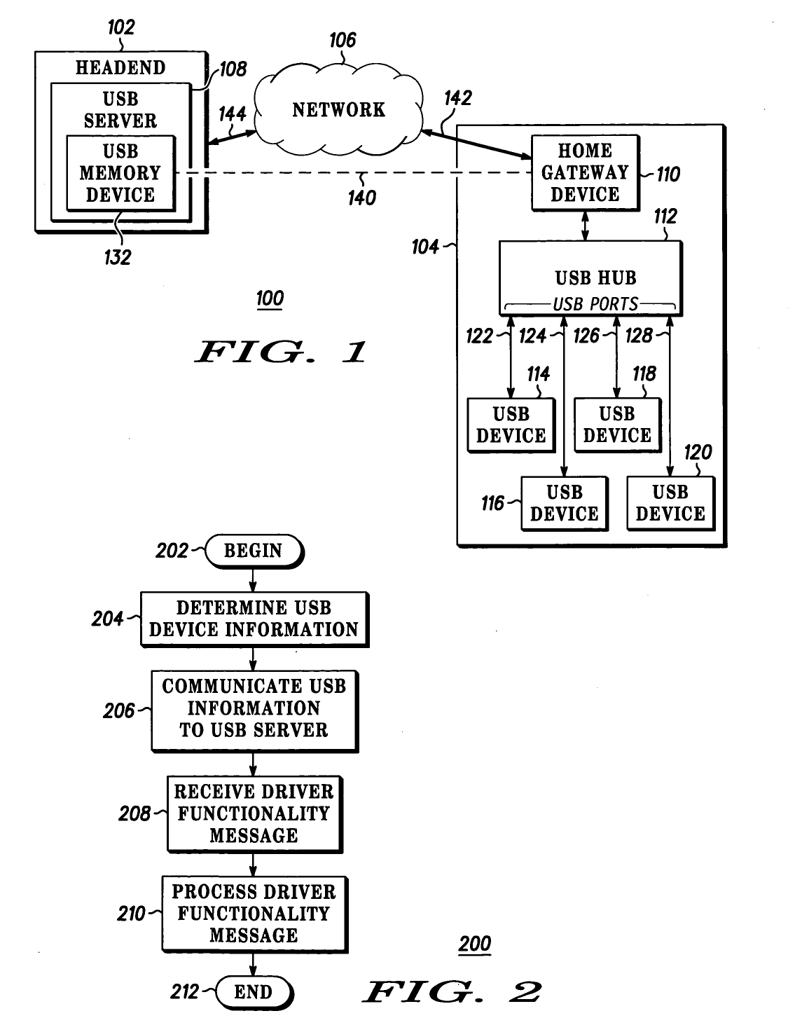

FIG. 1 is a block diagram of an exemplary interactive system in accordance with an embodiment of the present invention. System 100 comprises headend 102, subscriber location 104, and network 106. Headend 102 communicates to the subscriber location 104 via network 106, which may comprise a cable network or a wireless network.

Headend 102 comprises equipment for propagating a signal, such as a television signal, to the network 106. USB server 108 is located within headend 102 in exemplary system 100, but those skilled in the art will recognize that USB server 108 may be in any location in exemplary system 100 that enables communication with subscriber location 104.

Subscriber location 104 is an authorized location served by headend 102, such as a subscriber household or a subscriber business location. Subscriber location 104 comprises home gateway device 110, which is coupled to a USB hub 112 via a USB port 130. USB devices 114-120 are coupled to USB ports 122-128, respectively, on USB hub 112. These USB devices may comprise, but are not limited to, video cameras, printers, PVRs, or scanners.

Home gateway device 110 manages devices in subscriber location 104, and also, communications between subscriber location 104 and network 106 via network connection 142. In operation, the home gateway device 110 propagates signals received from network 106 via a network connection 142, such as a television signals, to various devices at the subscriber location 104, including but not limited to, televisions and USB devices. The home gateway device 110 is illustrated in further detail in FIG. 2.

The home gateway device 110 comprises a USB port 130. USB hub 112 comprises USB ports 122, 124, 126, and 128. In exemplary system 100, USB hub 112 is located externally to home gateway device 110, and is communicatively coupled to the USB port 130. Alternatively, the USB port 130 may be utilized to connect a single USB device, instead of coupling a USB hub 112. Furthermore, instead of utilizing USB hub 112 to provide multiple USB ports, the home gateway device 110 may comprise more than one USB ports 130. Those skilled in the art will recognize that all of these possibilities are within the spirit and scope of the present invention. For exemplary purposes only, the embodiment utilizing an external USB hub 112 coupled to the USB port 130 in exemplary system 100 is depicted for purposes of illustrating the present invention.

The USB server 108 comprises USB memory device 132, which may comprise either volatile or nonvolatile memory. USB memory device 132 stores information including but not limited to, USB drivers, USB device information, and other USB driver information. The USB server 108 is communicatively coupled to network 106, either directly or via resources located at the headend 102, via network connection 144.

The home gateway device 110 and the USB server 108 share an interactive path, shown as dotted line 140. This interactive path 140 may be supported via network 106, or by another communication channel. An intermediate messaging protocol may be utilized via the interactive path 140 to communicate messages back and forth, in essence creating a logical connection between home gateway device 110 and the USB server 108. Thus, via this interactive path 140, the USB server 108 may remotely provide the home gateway device 110 with USB driver functionality by sending and receiving messages comprising USB driver functionality. Hereinafter, these messages comprising USB driver functionality will be referred to as “driver functionality messages.” These driver functionality messages include instructions or information about the appropriate USB driver, which enable the home gateway device 110 to function as if the USB driver were present in the home gateway device memory 208. In an alternative embodiment, the driver functionality message may comprise the USB driver itself. These driver functionality messages are communicated from the USB server 108 to the home gateway device 110 via an intermediate message protocol that can be transported across network 106.

FIG. 2 is a flow diagram illustrating the method of the present invention from the perspective of the home gateway device 110. Method 200 begins at step 202 and proceeds to the home gateway device 110 determining the USB device information. This USB device information comprises information utilized to identify the USB device or the USB driver appropriate for the USB device. Identifying the USB device at step 206 may potentially comprise determining the type of USB device, although this also may be done either by the USB server 108, or not performed at all. In this latter circumstance, the present invention may operate with only details utilized to identify the USB driver appropriate for the USB device.

At step 206, the home gateway 110 communicates the USB device information to the USB server 108. This USB device information may be communicated across the interactive path 140, network 106, or any other communication channel between the home gateway device 110 and the USB server 108. This USB device information is received by the USB server 108 via network connection 144.

At step 208, the home gateway device 110 receives a message comprising USB driver functionality from the USB server 108. The USB server 108 communicates this message comprising USB driver functionality via an intermediate message protocol, which may comprise any protocol capable of transporting messages from the USB driver located on USB server 108. This message comprising USB driver functionality may comprise any instructions or other information which, when processed by the home gateway device 110, purports USB driver functionality to the home gateway device 110 as if the USB driver actually resided on the home gateway 110.

Once the message comprising USB driver functionality is received at step 208, the home gateway device 110 processes the instructions or other information within the message comprising USB driver functionality at step 210. Method 200 then terminates at step 212.

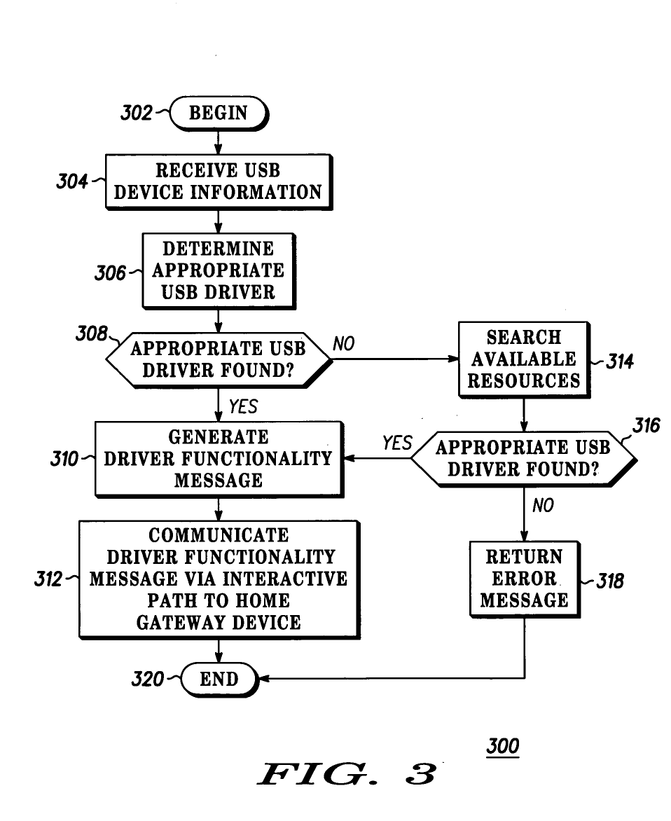

FIG. 3 is a flow diagram illustrating the method of the present invention, from the perspective of the USB server 108, when the USB server 108 does not comprise the USB driver for the USB device. Method 300 begins at step 302 and proceeds to the receipt of USB device information at step 304. The home gateway device 110 sends this USB device information to the USB server 108. This USB device information includes information utilized in the determination of the type of USB device, which is performed to determine the appropriate USB driver for the USB device.

At step 306, the USB server 108 determines the appropriate USB driver for the USB device. The USB server 108 searches USB 132 to locate the appropriate USB driver by analyzing the USB device information, and analyzing USB drivers pertinent to the USB device information.

If the USB server determines that an appropriate USB driver is found at 308, the USB server 108 generates a message comprising USB driver functionality at step 310. This message comprising USB driver functionality is then communicated to the home gateway 110 via the interactive path 140 at step 312. Method 300 then terminates at step 320.

If the USB server determines that an appropriate USB driver is not found at step 308, the USB server 108 searches available resources for an appropriate USB driver at step 312. Available resources may include searching vendor resources associated with the particular USB device, or searching the Internet for available USB drivers.

If after searching available resources at step 314, the USB server determines that an appropriate USB driver is not found at step 316, the USB server 108 returns an error message indicating that the USB device cannot be supported for lack of an appropriate driver at step 318. This error message may prompt the user for more information about the USB device, which could then be utilized to again search available resources for an available driver. Alternatively, the error message may prompt the user to select between two or more appropriate USB drivers. After the error message is generated at step 318, method 300 may terminate at 320.

In operation, method 300 may involve repetition of step 310 if more than one driver functionality message is needed to provide USB driver functionality to the home gateway device 110. Furthermore, method 300 may also comprise the receipt of communications from the home gateway device 110 directed to the USB server 108. When there are not any messages needed to provide USB driver functionality to the home gateway device 110, or when the need for the USB driver functionality on the home gateway device 110 terminates, method 300 concludes at step 320.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable carrier” for purposes of embodiments of the present invention may be any medium or transmission that can contain, store, communicate, propagate, or transport the program for use by or in connection with the instruction execution system, apparatus, system or device. The computer readable carrier can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention will include any and all embodiments and equivalents falling within the scope of the appended claims.

1. A method of providing USB device support in an interactive system, said method comprising the steps of:
determining USB device information;
communicating the USB device information to a USB server; and,
receiving a driver functionality message comprising information concerning the appropriate USB driver to support the USB device.

2. The method of claim 1, wherein determining USB device information comprises analyzing the USB device via a USB connection.

3. The method of claim 1, wherein communicating the USB device information to a USB server comprises communicating the USB device information to the USB server via an interactive path across a network.

4. The method of claim 3, wherein communicating the USB device information to a USB server comprises communicating the USB device information to the USB server via an interactive path across a wireless network.

5. The method of claim 3, wherein communicating the USB device information to a USB server comprises communicating the USB device information to the USB server via an interactive path across a cable network.

6. The method of claim 1, wherein receiving a driver functionality message comprises receiving a message comprising functionality for the appropriate USB driver for the USB device via an intermediate message protocol.

7. The method of claim 1, wherein receiving a driver functionality message comprises receiving a message comprising the appropriate USB driver.

8. A method of providing USB device support to a home gateway device in an interactive system, said method comprising the steps of:
receiving USB device information;
determining the appropriate USB driver for the USB device; and,
communicating a driver functionality message comprising USB driver functionality for the appropriate USB driver.

9. The method of claim 8, wherein determining the USB driver for the USB device comprises determining a type of USB device by analyzing the USB device information.

10. The method of claim 9, wherein communicating a driver functionality message comprises communicating a message comprising instructions for the home gateway device based on the USB driver for the type of USB device.

11. The method of claim 8, wherein communicating a driver functionality message to the home gateway device comprises communicating a message comprising the USB driver.

12. An apparatus for providing USB class support in an interactive system, said apparatus comprising:
a USB port for connecting to comprising to a USB device; and,
a network connection to a USB server;
wherein the apparatus determines USB device information, communicates the USB device information to a USB server, and receives a driver functionality message to support the USB device.

13. The apparatus of claim 12, wherein said USB port is coupled to a USB hub.

14. The apparatus of claim 12, wherein said network connection to a USB server comprises a network connection via a wireless network to a USB server.

15. The apparatus of claim 12, wherein said network connection to a USB server comprises a network connection via a cable network to a USB server.

16. An apparatus for providing USB driver functionality to a USB device coupled to a home gateway device in an interactive system, said apparatus comprising:
a USB memory device, said USB memory device comprising memory for storing USB driver information associated with a USB driver; and
an interactive path connection to a home gateway device;
wherein said apparatus receives USB device information; determines the appropriate USB driver for the USB device; and communicates a driver functionality message comprising USB driver functionality for the appropriate USB driver.

17. The apparatus of claim 16, wherein said USB memory device comprises USB driver information

18. The apparatus of claim 16, wherein said interactive path is supported by a network.

19. The apparatus of claim 18, wherein said network comprises a wireless network.

20. The apparatus of claim 18, wherein said network comprises a cable network.

21. A system for providing USB class support in an interactive system, said apparatus comprising:
a home gateway device, said home gateway device comprising a USB port coupled to a USB device and a network connection to a network;
a USB server, said USB server comprising a USB memory device for storing USB driver information associated with a USB driver and a network connection to a network;
wherein said system communicates USB device information from the home gateway device to the USB server, and communicates a driver functionality message from the USB server to the home gateway device.

22. The system of claim 21, wherein said home gateway device network connection and said USB server network connection create an interactive path between the USB server and the home gateway device.

23. The system of claim 22, wherein said interactive path provides for driver functionality messages to be communicated from the USB server to the home gateway device via an intermediate messaging protocol.

24. The system of claim 22, wherein said interactive path is supported by a cable network.

25. A computer-readable carrier including computer program instructions that instruct a computer to perform the steps of:
determining USB device information;
communicating the USB device information to a USB server; and
receiving a driver functionality message comprising information concerning the appropriate USB driver to support the USB device.

26. The computer readable carrier of claim 25, wherein accepting a USB device via a connection to a USB port comprises receiving the USB device through a connection to a USB port on a USB hub.

27. The computer readable carrier of claim 25, wherein determining USB device information comprises analyzing the USB device via the USB connection to determine the type of USB device.

28. The computer readable carrier of claim 25, wherein communicating the USB device information to a USB server comprises communicating the USB device information to the USB server across a network.

29. The computer readable carrier of claim 28, wherein communicating the USB device information to a USB server comprises communicating the USB device information to the USB server across a wireless network.

30. The computer readable carrier of claim 28, wherein communicating the USB device information to a USB server comprises communicating the USB device information to the USB server across a wireless network.

31. The computer readable carrier of claim 25, wherein receiving a message comprising USB driver functionality to support the USB device comprises receiving a message comprising functionality for the USB driver for the USB device via an intermediate message protocol.
